(19) United States
(12) Patent Application Publication
(10) Pub. No.: US 2010/0208140 A1
(43) Pub. Date: Aug. 19, 2010

(54) IMAGE PROCESSING APPARATUS, IMAGE PROCESSING METHOD AND STORAGE MEDIUM STORING IMAGE PROCESSING PROGRAM

(75) Inventor: Munenori FUKUNISHI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/701,764

(22) Filed: Feb. 8, 2010

(30) Foreign Application Priority Data
Feb. 13, 2009 (JP) 2009-31899

(51) Int. Cl. H04N 5/21

(52) U.S. Cl. 348/576; 348/E05.077

(57) ABSTRACT

An image processing apparatus includes a motion vector detection unit that determines a motion vector between a plurality of images obtained in time series, an image synthesis unit that obtains a synthesized image by correcting a positional deviation between the plurality of images on the basis of the determined motion vector and synthesizing the plurality of images subjected to the positional deviation correction, a smoothing area extraction unit that extracts a smoothing area in which smoothing processing is to be performed on the basis of a degree of inconsistency occurring when the positional deviation is corrected, and a smoothing processing unit that performs the smoothing processing on the extracted smoothing area, from among respective areas of the synthesized image.

### TECHNICAL FIELD OF THE INVENTION

This invention relates to an image synthesis technique using a plurality of images captured in time series.

### BACKGROUND OF THE INVENTION

During conventional camera photography, a photography technique known as a “follow shot” is used to photograph a moving object such as a train, an automobile, or a sport scene. A “follow shot” is a technique in which image pickup is performed while moving (panning) the camera in accordance with movement of the object so that an object position within a finder (an image) of the object is static. With follow shot photography, an image in which a background appears to flow but the object does not blur can be obtained, and therefore an image expressing a sense of speed can be obtained. In actuality, however, it is not easy to fix the object position within the image during image pickup (during a period in which a shutter is open and an imaging device is exposed), and therefore the object is often blurred. Methods such as sensing a movement direction of the camera during image pickup using an angular velocity sensor and suppressing a blur component in a direction that is not the movement direction of the camera by shifting an optical system or the imaging device have been employed as typical conventional methods of dealing with this problem. For example, when the camera pans in a horizontal direction, vertical direction blur is suppressed.

JP2007-074031A discloses a method in which an image area is divided into a mesh form, the respective areas are divided into a target area and other areas using motion vectors of the respective areas, and a smoothing filter for producing a similar blur effect to that of a follow shot is applied to the part that is not the target area.

### SUMMARY OF THE INVENTION

An image processing apparatus of an aspect of the present invention comprises a motion vector determination unit that determines a motion vector between a plurality of images obtained in time series, an image synthesis unit that obtains a synthesized image by correcting a positional deviation between the plurality of images on the basis of the determined motion vector and synthesizing the plurality of images subjected to the positional deviation correction, a smoothing area extraction unit that extracts a smoothing area in which smoothing processing is to be performed on the basis of a degree of inconsistency occurring when the positional deviation between the plurality of images is corrected, and a smoothing processing unit that performs the smoothing processing on the extracted smoothing area, from among respective areas of the synthesized image.

An image processing apparatus of another aspect of the present invention comprises a motion vector determination unit that determines a motion vector between a plurality of images obtained in time series, a smoothing area extraction unit that extracts a smoothing area in which smoothing processing is to be performed on the basis of a degree of inconsistency occurring when a positional deviation between the plurality of images is corrected, a smoothing processing unit that performs the smoothing processing on the extracted smoothing area, from among respective areas of the plurality of images, and an image synthesis unit that obtains a synthesized image by correcting the positional deviation between the plurality of images subjected to the smoothing processing on the basis of the motion vector and synthesizing the plurality of images subjected to the positional deviation correction.

An image processing method of yet another aspect of the present invention comprises a step of determining a motion vector between a plurality of images obtained in time series, a step of obtaining a synthesized image by correcting a positional deviation between the plurality of images on the basis of the determined motion vector and synthesizing the plurality of images subjected to the positional deviation correction, a step of extracting a smoothing area in which smoothing processing is to be performed on the basis of a degree of inconsistency occurring when the positional deviation between the plurality of images is corrected, and a step of performing the smoothing processing on the extracted smoothing area, from among respective areas of the synthesized image.

An image processing method of yet another aspect of the present invention comprises a step of determining a motion vector between a plurality of images obtained in time series, a step of extracting a smoothing area in which smoothing processing is to be performed on the basis of a degree of inconsistency occurring when a positional deviation between the plurality of images is corrected, a step of performing the smoothing processing on the extracted smoothing area, from among respective areas of the plurality of images, and a step of obtaining a synthesized image by correcting the positional deviation between the plurality of images subjected to the smoothing processing on the basis of the motion vector and synthesizing the plurality of images subjected to the positional deviation correction.

A recording medium of yet another aspect of the present invention stores an image processing program. The image processing program causes a computer to execute a step of determining a motion vector between a plurality of images obtained in time series, a step of obtaining a synthesized image by correcting a positional deviation between the plurality of images on the basis of the determined motion vector and synthesizing the plurality of images subjected to the positional deviation correction, a step of extracting a smoothing area in which smoothing processing is to be performed on the basis of a degree of inconsistency occurring when the positional deviation between the plurality of images is corrected, and a step of performing the smoothing processing on the extracted smoothing area, from among respective areas of the synthesized image.

A recording medium of yet another aspect of the present invention stores an image processing program. The image processing program causes a computer to execute a step of determining a motion vector between a plurality of images obtained in time series, a step of extracting a smoothing area in which smoothing processing is to be performed on the basis of a degree of inconsistency occurring when a positional deviation between the plurality of images is corrected, a step of performing the smoothing processing on the extracted smoothing area, from among respective areas of the plurality of images, and a step of obtaining a synthesized image by correcting the positional deviation between the plurality of images subjected to the smoothing processing on the basis of the motion vector and synthesizing the plurality of images subjected to the positional deviation correction.

### BRIEF DESCRIPTION OF THE DRAWINGS

FIG. 1 is a view showing the constitution of an image processing apparatus according to a first embodiment of this invention.

FIG. 2 is a flowchart showing an overall processing flow executed by the image processing apparatus according to the first embodiment.

FIG. 3A is a view showing a processing area of the positioning processing performed on a reference frame, and FIG. 3B is a view showing a processing area of the positioning processing performed on a positioning subject frame.

FIG. 4A is a view showing an example of motion vectors of respective template blocks, and FIG. 4B shows reliable motion vectors remaining after unreliable motion vectors have been excluded.

FIG. 5 is a view showing examples of voting processing results obtained in relation to reliable motion vectors on a histogram.

FIG. 6 is a view illustrating a method of performing positioning using images obtained by continuously shooting four frames.

FIG. 7 is a view illustrating a method of performing positioning using an area that centers on a focus measurement point used during focusing.

FIGS. 8A and 8B are views illustrating a method of performing positioning using an object area specified by a user.

FIG. 9A shows an example of an average motion vector between frames, and FIG. 9B shows an average filter kernel obtained based on the average motion vector.

FIG. 10 is a flowchart showing a processing flow of smoothing area extraction processing.

FIG. 11 shows, in descending order, a luminance value of an image of a first frame, a luminance value of an image of a second frame, a luminance value of an image of a third frame, a total luminance value of the images of the first to third frames, and a difference between a maximum value and a minimum value of the luminance values of the images of the first to third frames.

FIGS. 12A and 12B show, in descending order, the luminance value of the image of the first frame, the luminance value of the image of the second frame, a luminance value obtained when the image of the first frame and the image of the second frame are overlapped, and a difference between the luminance values of the image of the first frame and the image of the second frame.

FIG. 13 is a view illustrating effects and characteristics of a smoothing area extraction processing.

FIG. 14 is a view showing the constitution of an image processing apparatus according to a second embodiment.

FIG. 15 is an overall processing flow performed by the image processing apparatus according to the second embodiment.

### DESCRIPTION OF THE PREFERRED EMBODIMENTS

### First Embodiment

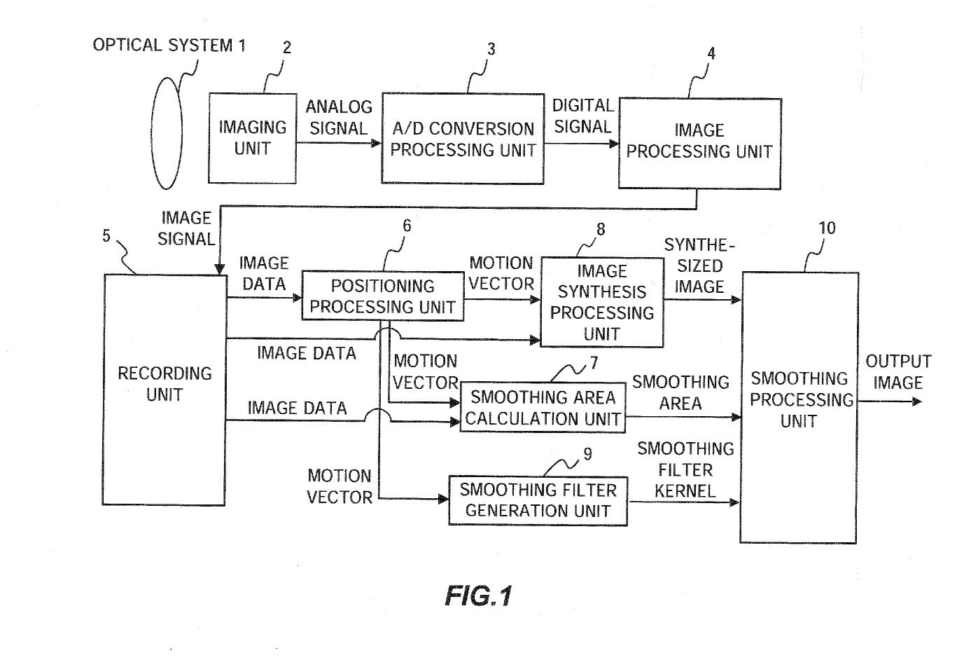

FIG. 1 is a view showing the constitution of an image processing apparatus according to a first embodiment of this invention. In the drawing, arrows indicate the flow of data. The image processing apparatus according to this embodiment is installed in an electronic device that is dependent on a current or an electromagnetic field to operate correctly, such as a digital camera, a digital video camera, or an endoscope.

Light taken in by the optical system 1 is converted into an electric signal by an imaging unit 2 and output as an analog signal. The A/D conversion processing unit 3 converts the analog signal output by the imaging unit 2 into a digital signal. An image processing unit 4 performs noise removal processing, demosaicing processing (processing for allocating three values of RGB to each pixel from a state in which only one signal of RGB signals exists in each pixel), and the like on the digital signal to convert the digital signal into an image signal. The image signal is accumulated in the recording unit 5. The data flow series up to this point is executed each time image pickup is performed.

During continuous shooting, the data flow described above is executed for each of the continuous shots. A positioning processing unit 6 determines an inter-image data motion vector (positional deviation) on the basis of data relating to the plurality of images accumulated in the recording unit 5. An image synthesis processing unit 8 corrects a positional deviation between the data relating to the plurality of images on the basis of the data relating to the plurality of images and the motion vector, and performs synthesis processing on the data relating to the positioned images to output a synthesized image.

A smoothing area calculation unit 7 determines a smoothing area within the synthesized image on the basis of the data relating to the plurality of images and the motion vector. A smoothing filter generation unit 9 determines a filter kernel of a smoothing filter on the basis of the motion vector. A smoothing processing unit 10 obtains an output image exhibiting a follow shot effect by performing smoothing processing on the smoothing area from among respective areas of the synthesized image.

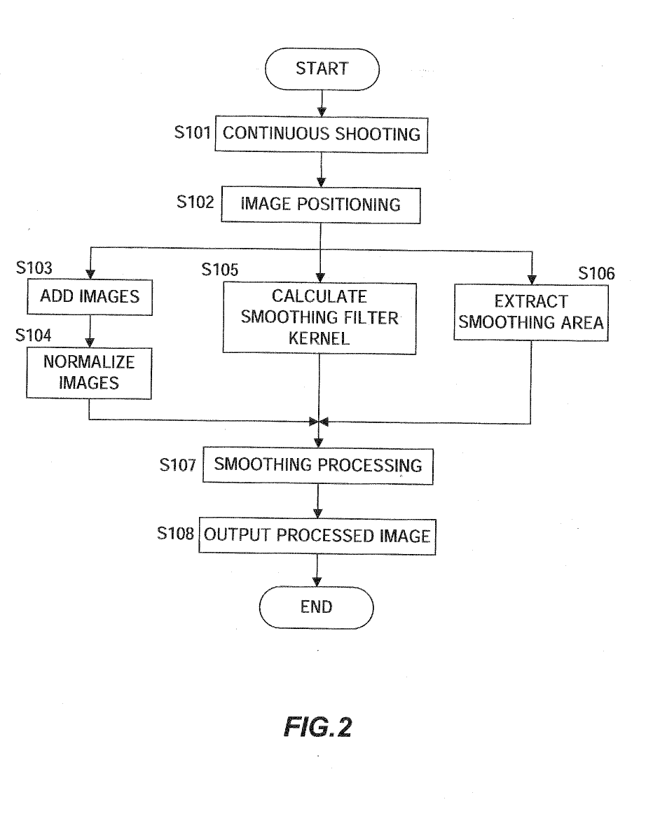

FIG. 2 is a flowchart showing an overall processing flow executed by the image processing apparatus according to the first embodiment.

In a step S101, the imaging unit 2 performs continuous shooting to obtain a plurality of images that are continuous in time series. The obtained plurality of images are processed by the A/D conversion processing unit 3 and the image processing unit 4, respectively, and then recorded in the recording unit 5.

In a step S102, positioning processing is performed by the positioning processing unit 6 using the plurality of images recorded in the recording unit 5, whereby a motion vector indicating positional deviation between the images is determined. Hereafter, an image that serves as a positioning reference will be referred to as a reference frame and an image that is positioned relative to the reference frame will be referred to as a positioning subject frame (or a subject frame). The reference frame is set using any one of the continuous images as a positioning reference coordinate system. The positioning subject frame is set by setting images other than the reference frame in sequence. For example, when a first frame is set as the positioning reference, the second and subsequent frames are set as the positioning subject frame. In the positioning processing, a movement amount of an image in the second frame onward from the first frame is calculated.

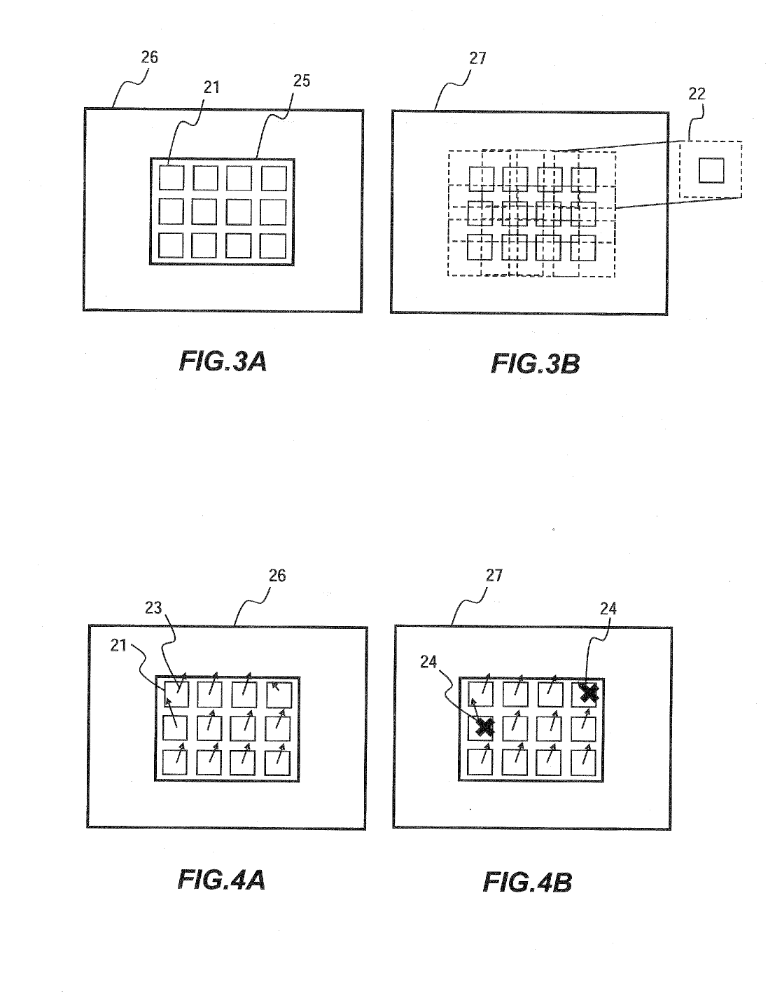

FIGS. 3A and 3B are views showing a processing area of the positioning processing performed on the reference frame and the positioning subject frame. As shown in FIG. 3A, a plurality of positioning template blocks 21 are set within a predetermined area 25 in a central part of a positioning subject frame 26. The template blocks 21 are rectangular areas of a predetermined size, which are used to determine the motion vector.

FIG. 3B is a view showing search areas 22 set in the reference frame 27. The search areas 22 are set in the reference frame 27 in a wider area than the template blocks 21 and in the vicinity of coordinates corresponding to the template blocks 21.

During motion vector calculation, an alignment index indicating a degree of position overlap is calculated by scanning the template block 21 in the positioning subject frame 26 within the search area 22 of the reference frame 27. A position in which the alignment index is largest (or smallest, depending on the type of the alignment index) is set as a positioning correspondence point, and a relative positional deviation from the template block 21 is set as the motion vector. A SAD (Sum of Absolute intensity Difference), for example, which is the sum of absolute values of an inter-frame luminance difference, may be used as the alignment index. The degree of alignment is determined to be greater as the SAD decreases. When a pixel included in a template block area I of the reference frame 27 is set as p (pεI), a pixel included in a positioning processing area I′ of the positioning subject frame 26 is q (qεI′), and luminance values are set as Lp, Lq respectively, SAD is obtained from a following Equation (1).

$$S A D ( I , {I}^{′} ) = {\sum }_{p ∈ I , q ∈ {I}^{′}} {‖ Lp - Lq ‖}_{1} \qquad ( 1 )$$

Alternatively, an SSD (Sum of Squared intensity Difference), in which a squared error is calculated, an NCC (Normalized Cross-Correlation), in which a normalized cross-correlation is calculated, and so on may be used as the alignment index. By employing the procedures described above, a motion vector can be determined for each of the template blocks 21 shown in FIG. 3A.

FIG. 4A is a view showing examples of motion vectors 23 of the respective template blocks 21. The motion vectors of the respective template blocks 21 determined by the method described above include reliable and unreliable motion vectors. For example, in a low-contrast area lacking positioning clues, the reliability of the motion vector is low. In a high-contrast area, on the other hand, a highly reliable result is more likely to be obtained.

Hence, using contrast information relating to each template block 21, the reliability of the motion vector 23 of each block is determined, whereupon unreliable motion vectors, or in other words motion vectors of low-contrast areas, are excluded from subsequent calculations. FIG. 4B shows reliable motion vectors remaining after unreliable motion vectors 24 have been excluded.

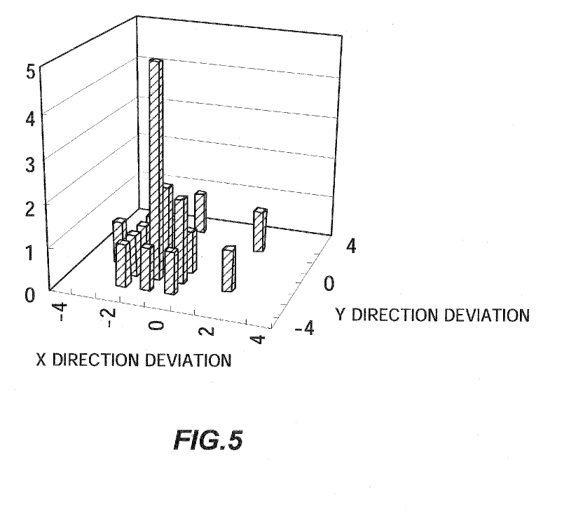

Next, voting processing is performed on the remaining reliable motion vectors to select a most frequent motion vector, or in other words a most numerous motion vector. FIG. 5 is a view showing examples of voting processing results obtained in relation to reliable motion vectors on a histogram. The most frequent motion vector is determined by breaking down the reliable motion vectors into an X direction deviation and a Y direction deviation and then performing voting processing. The most frequent motion vector is set as a representative motion vector between the reference frame and the positioning subject frame.

As described above, in this embodiment, the motion vector is detected in the predetermined area 25 in the central part of the image. The reasons for this are that a main object is assumed to be in the central part of the image and the majority of main objects are located in the central part of the image. It should be noted that with this method, although the main object may be in the central part of a screen at the start of continuous shooting, the main object may move so as to deviate from the central part of the screen. In response to this problem, a first positioning operation may be performed in the central portion of the image, whereupon second and subsequent positioning operations are performed in the vicinity of a motion vector obtained from a previous positioning result.

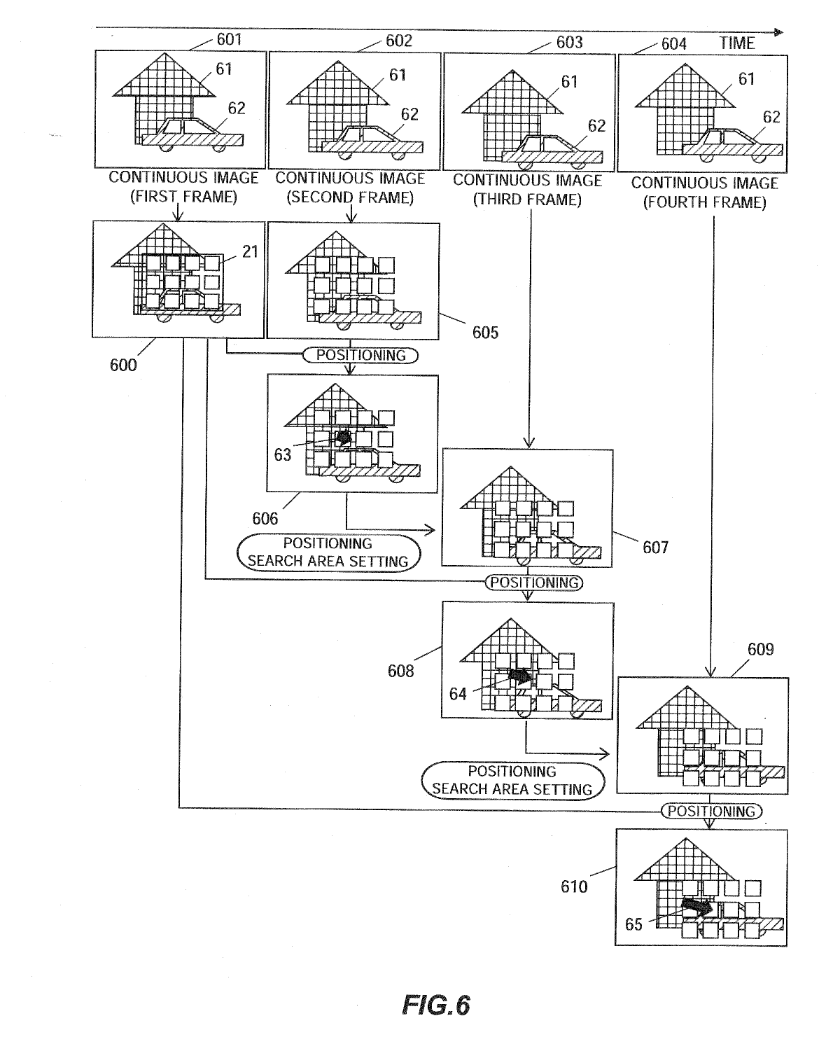

FIG. 6 is a view illustrating a method of performing positioning using images 601 to 604 obtained by continuously shooting four frames. Each of the images 601 to 604 depicts a house 61 that does not move on the image and a moving vehicle 62. In this case, the vehicle 62 serves as the main object.

An image 600 is a diagram in which a plurality of the template blocks 21 are set on the image 601 of the first frame. By employing the method described above to perform scanning on the image 602 of the second frame using the template blocks 21 (image 605), positioning is performed between the image 601 and the image 602. A motion vector 63 determined by the positioning is indicated on an image 606.

The image 603 of the third frame is positioned taking into account the motion vector 63, i.e. the result of the first positioning operation. More specifically, the image of the third frame is positioned by performing scanning around positions obtained by moving each of the template blocks 21 set on the first frame 600 by the motion vector 63 (image 607). A motion vector 64 determined by the positioning is indicated on an image 608.

The image 604 of the fourth frame is positioned taking into account the motion vector 64, i.e. the result of the second positioning operation. More specifically, the image of the fourth frame is positioned by performing scanning around positions obtained by moving each of the template blocks 21 set on the first frame 600 by the motion vector 64 (image 609). A motion vector 65 determined by the positioning is indicated on an image 610.

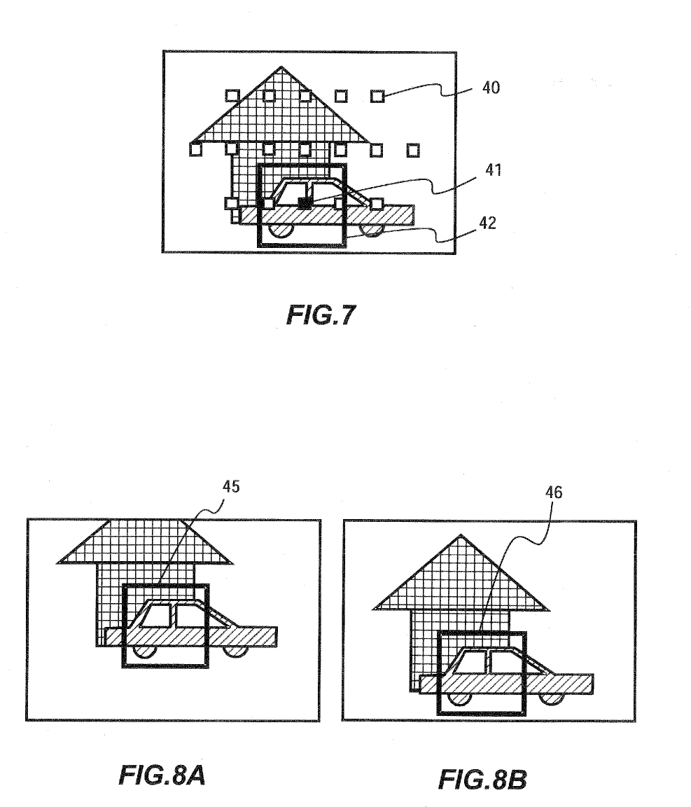

A first modified example of the positioning processing will now be described using FIG. 7. In the positioning processing (motion vector detection processing) described above, it is assumed that the main object is located in a central part of the image, but it may be assumed that a part which is most in focus is the main object. In camera photography, a plurality of focus measurement points 40 are disposed on a screen. Hence, the positioning processing (motion vector detection processing) may be performed using an area 42 that centers on a focus measurement point 41 used during focusing.

A second modified example of the positioning processing will now be described using FIGS. 8A and 8B. FIG. 8A shows an image of a first frame, from among a plurality of images obtained through continuous shooting, and FIG. 8B shows an image of a second frame.

During normal camera photography, a shutter is depressed in two stages. In the first stage of the depression, imaging parameters such as the focus, shutter speed, and F value are confirmed, and in the second stage of the depression, image pickup is performed. During the first stage of the depression, a user specifies an area 45 of a predetermined size in a central part of the screen as the main object. In other words, the user sets an imaging area such that the approximate center of the main object is located in the center of the screen. Continuous shooting is then performed during the second stage of the depression.

When the inter-image positional deviation is determined, an area having color and luminance values that are close to those of the object area 45 specified by the user is found, and thus precise positioning processing may be performed in the vicinity of this area. A well known technique such as an active search method using an inter-color histogram similarity value, a mean-shift method, or a particle filter may be employed as a method of finding the area having close color and luminance values. In FIG. 8B, an area 46 is indicated as an area that closely matches the object area 45 shown in FIG. 8A.

In a step S103 of the flowchart shown in FIG. 2, the image synthesis processing unit 8 adds together the plurality of images while correcting positional deviation between the images on the basis of the motion vector determined in the step S102. In a case where the images 601 to 604 shown in FIG. 6 are added together, positional deviation between the images is corrected using the main object vehicle 62 as a reference, whereupon the corrected images are added together. In a step S104, the image synthesis processing unit 8 normalizes the added images by an addition count to obtain a synthesized image.

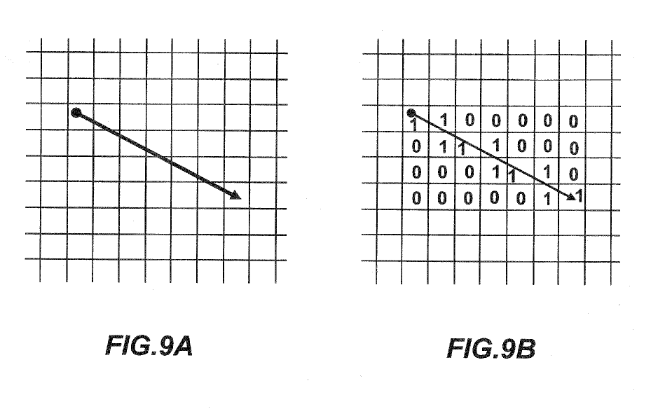

In a step S105, the smoothing filter generation unit 9 determines a smoothing filter kernel on the basis of the motion vector determined in the step S102. A method of determining the smoothing filter kernel will now be described using FIG. 9.

Object movement and a background flow condition are considered to have an approximately inverse vector relationship. Hence, a smoothing filter kernel corresponding to the inverse vector is generated on the basis of the motion vector of the object. An average motion vector of the motion vectors determined in the respective positioning subject frames during the image positioning processing (step S102) is set as the motion vector of the object. FIG. 9A is a view showing an example of a determined average motion vector.

FIG. 9B shows a relationship between the motion vector and the filter kernel. It is assumed that the filter kernel moves at a constant speed in the motion vector direction, and therefore smoothing filters having an identical weight are generated in the motion vector direction. It should be noted that a motion vector between a first frame and a final frame may be used instead of the average motion vector.

In a step S106, the smoothing area calculation unit 7 extracts a smoothing area for performing smoothing processing on the basis of the data relating to the plurality of images and the motion vector. When continuously shot images are positioned using an object as a reference, unnatural bumps in level occur in the background part of the synthesized image. The processing of the step S106 is performed with the aim of extracting a processing area in which smoothing processing for reducing these bumps in level is to be performed.

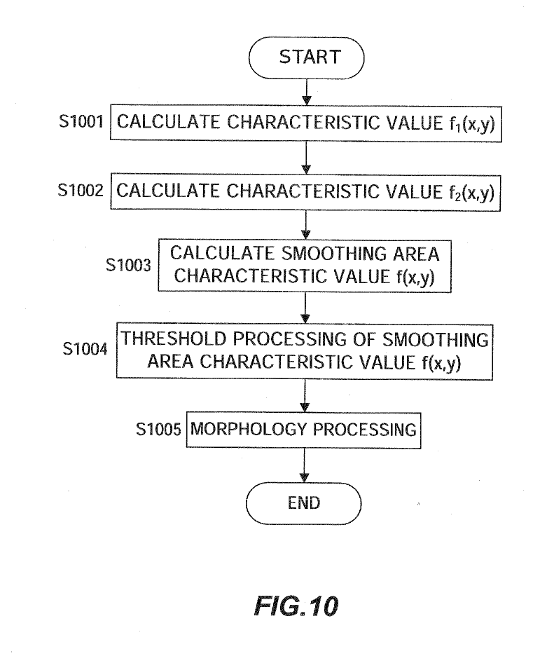

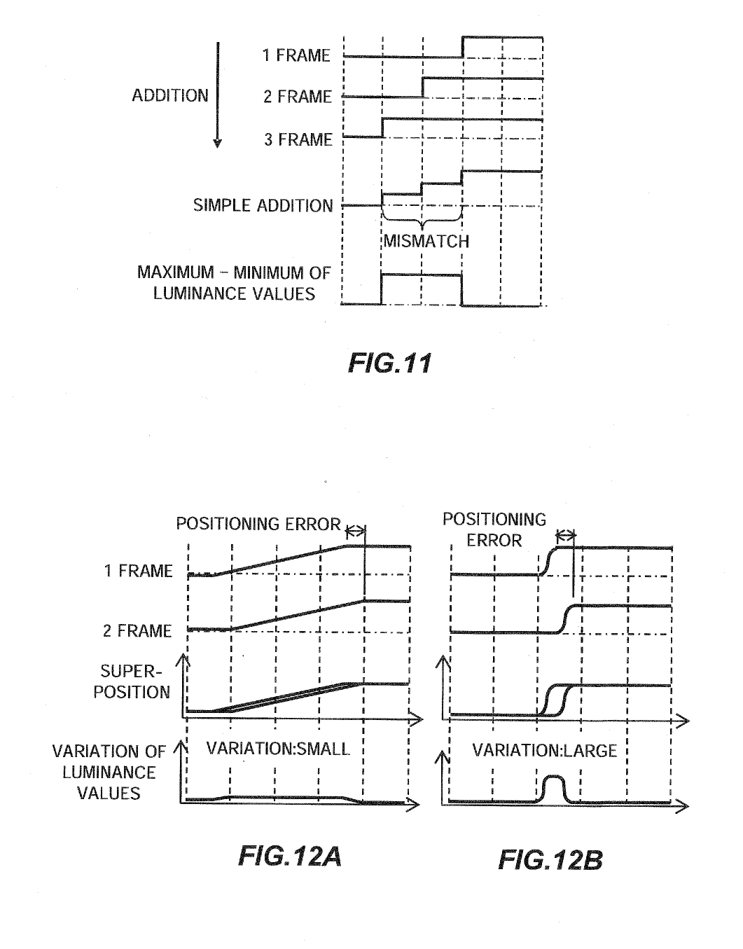

FIG. 10 is a flowchart showing a processing flow of smoothing area extraction processing. In a step S1001, a first characteristic value f₁ (x, y) representing a degree of positioning inconsistency between the images of the synthesized image is calculated. A method of calculating the first characteristic value f₁ (x, y) will now be described using FIG. 11.

FIG. 11 shows, in descending order, a luminance value of an image of a first frame, a luminance value of an image of a second frame, a luminance value of an image of a third frame, a total luminance value of the images of the first to third frames, and a difference between a maximum value and a minimum value of the luminance values of the images of the first to third frames.

In the synthesized image, the object is positioned to the reference, and therefore, in the object part, images having substantially identical luminance values are added together. In the background part, on the other hand, images having different luminance values are added together, and this leads to bumps in level in the background part of the synthesized image (see FIG. 11).

Hence, a degree of variation between the luminance values of the added images is determined as the first characteristic value f₁ (x, y). More specifically, a difference between the luminance values of the respective positioned images is defined as the first characteristic value f₁ (x, y) and determined using a following Equation (2). In Equation (2), N is the number of added images, (Vx (n), Vy (n)) is the motion vector of an nth image, and Iₙ (x, y) is the luminance value in a pixel (x, y) of the nth image.

$${f}_{1} ( x , y ) = {max}_{n ∈ N} ( \begin{matrix}{I}_{n} ( x + Vx ( n ) , \\ y + Vy ( n ) )\end{matrix} ) - {min}_{n ∈ N} ( \begin{matrix}{I}_{n} ( x + Vx ( n ) , \\ y + Vy ( n ) )\end{matrix} ) \qquad ( 2 )$$

In a step S1002, a second characteristic value f₂ (x, y) indicating the effect of the positioning error on the synthesized image is calculated. A method of calculating the second characteristic value f₂ (x, y) will now be described using FIGS. 12A and 12B.

FIGS. 12A and 12B show, in descending order, the luminance value of the image of the first frame, the luminance value of the image of the second frame, a luminance value obtained when the image of the first frame and the image of the second frame are overlapped, and a difference (variation) between the luminance values of the image of the first frame and the image of the second frame. FIG. 12A shows an example of a case in which a positioning error exists when the two images are overlapped but the luminance value difference caused by the positioning error is small, and FIG. 12B shows an example of a case in which the luminance value difference caused by the positioning error is large.

During actual positioning processing, a positioning error occurs. The second characteristic value f₂ (x, y) is used to cancel out adverse effects caused by the positioning error. With the first characteristic value f₁ (x, y), a luminance value difference is calculated, but when a positioning error exists, the luminance value difference varies. In an area where a luminance gradient, i.e. the degree of variation in the luminance value, is small, the effect of the positioning error on the luminance value difference is small. In an area where the luminance gradient is large, on the other hand, variation in the luminance value difference increases even when the positioning error remains the same. To eliminate this effect, the variation applied to the luminance difference by the positioning error is determined as the second characteristic value f₂ (x, y) using a following Equation (3).

$${f}_{2} ( x , y ) = α \cdot \{ \begin{matrix}{max}_{- 1 \leq i \leq 1 , - 1 \leq j \leq 1} ( {I}_{0} ( x + i , y + j ) ) - \\ {min}_{- 1 \leq i \leq 1 , - 1 \leq j \leq 1} ( {I}_{0} ( x + i , y + j ) )\end{matrix} \} \qquad ( 3 )$$

In Equation (3), a is an image positioning precision in pixel units, and I₀ (x, y) is the luminance value of the pixel (x, y) in the reference image. An arbitrary image from among the N added images, such as a leading image or an intermediate image, for example, may be set as the reference image. It should be noted that in normal positioning processing, the positioning precision a may be learned in advance through analysis. Here, terms other than a in Equation (3) indicate a worst value of the luminance variation when positioning deviates by a single pixel. By multiplying the worst value by the positioning precision α, luminance variation caused by the positioning error can be determined in each location of the image.

In a step S1003, a smoothing area characteristic value f (x, y) is determined on the basis of the first characteristic value f₁ (x, y) determined in the step S1001 and the second characteristic value f₂ (x, y) determined in the step S1002 using a following Equation (4).

f(x,y)=f₁(x,y)−f₂(x,y) (4)

In a step S1004, threshold processing is performed to compare the smoothing area characteristic value f (x, y) determined in the step S1003 with a predetermined threshold Th. When the smoothing area characteristic value f (x, y) is equal to or greater than the predetermined threshold Th, Area (x, y)=1 is set, and when the smoothing area characteristic value f (x, y) is smaller than the predetermined threshold Th, Area (x, y)=0 is set. In other words, a relationship shown in a following Equation (5) is established. An area in which Area (x, y)=1 is set as the smoothing area.

$$Area ( x , y ) = \{ \begin{matrix}1 ( f ( x , y ) \geq Th ) \\ 0 ( f ( x , y ) < Th )\end{matrix} \qquad ( 5 )$$

In a step S1005, the smoothing area is determined by performing well known morphology processing (closing processing) on the area in which Area (x, y)=1. The area in which Area (x, y)=1 obtained in the step S1004 may be divided into very small areas, and this processing is performed to connect these very small areas.

It should be noted that in the processing (the step S1001) for calculating the first characteristic value f₁ (x, y), description focused on the difference between the maximum value and minimum value of the luminance value between the plurality of positioned images. However, an absolute value of the difference between the maximum value and minimum value of the luminance value, a luminance value dispersion, a standard deviation of the luminance value, a hue difference, an absolute value of the hue difference, a hue dispersion, a standard deviation of the hue, a chroma difference, an absolute value of the chroma difference, a chroma dispersion, a standard deviation of the chroma, and so on may be used instead. In this case, similar effects can be obtained in the processing (the step S1002) for calculating the second characteristic value f₂ (x, y) by determining the variation, in the luminance value, hue, or chroma caused by positional deviation.

Returning to the flowchart shown in FIG. 2, in a step S107, the smoothing processing unit 10 performs smoothing processing on the basis of the synthesized image obtained through the processing of the step S104, the smoothing filter kernel obtained through the processing of the step S105, and the smoothing area obtained through the processing of the step S106. More specifically, smoothing processing is performed on luminance values of the pixels within the smoothing area obtained through the processing of the step S106, from among luminance values of the respective pixels constituting the synthesized image obtained through the processing of the step S104, using the smoothing filter kernel obtained through the processing of the step S105.

In a step S108, the smoothing processing unit 10 outputs the image obtained in the step S107.

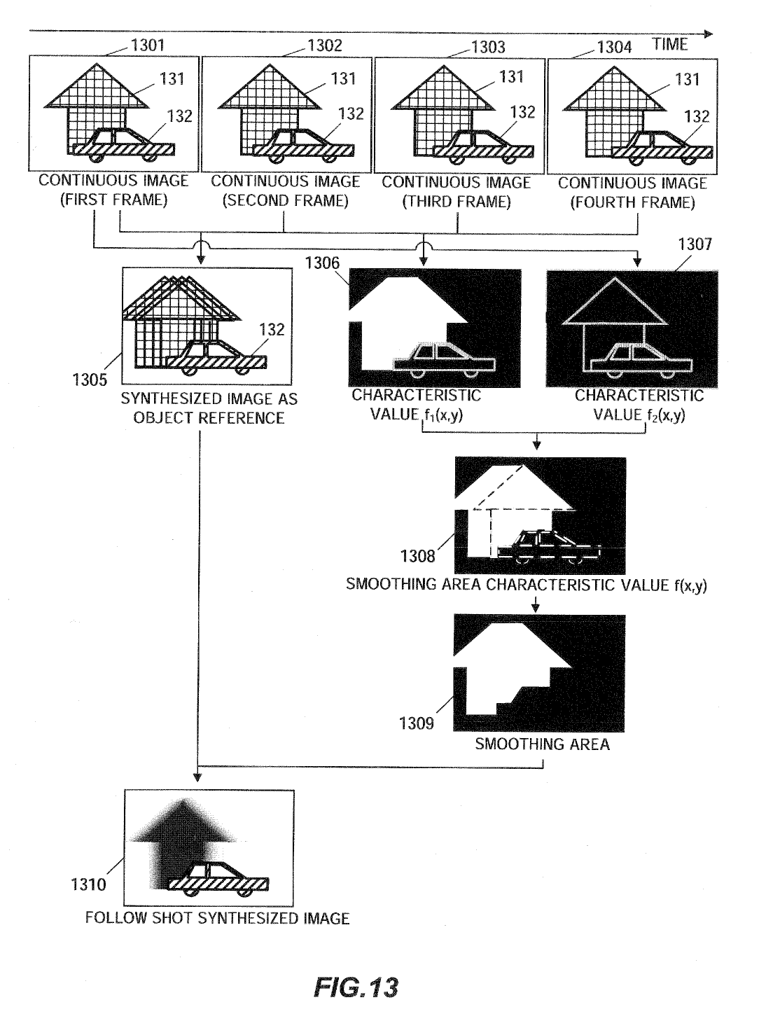

Effects and characteristics of the processing performed in the step S106, or in other words the smoothing area extraction processing, will now be described using FIG. 13. FIG. 13 shows an example in which positioning is performed using images 1301 to 1304 obtained by shooting four frames continuously. Each of the images 1301 to 1304 depicts a house 131 that does not move on the image and a moving vehicle 132.

An image 1305 is a synthesized image obtained by positioning the images 1301 to 1304 using the vehicle 132, which serves as the main object, as a reference. When continuous images are positioned and synthesized using a moving object as a reference, an image in which bumps in level occur on the background part is obtained. The first characteristic value f₁ (x, y) takes a large value in the house 131, which forms a part of the background part, and in the vicinity of edges of the vehicle 132 serving as the main object (see image 1306). The second characteristic value f₂ (x, y) takes a large value near the edges of the house 131 and the vehicle 132 (see image 1307). By determining a difference between the first characteristic value f₁ (x, y) and the second characteristic value f₂ (x, y), a smoothing area characteristic value f (x, y) is determined (see image 1308), and by performing threshold processing, the smoothing area is obtained (see image 1309).

When this processing is performed, the reference object part (the vehicle 132) is not included in the smoothing area (a white area), and the only area in which bumps in level are likely to occur can be extracted in the background area as the smoothing area. By performing smoothing processing in the smoothing area, background bumps in level can be suppressed without adversely affecting the reference object. In other words, rather than smoothing the entire background area, smoothing is performed only in the area of the synthesized image in which bumps in level occur.

Hence, there is no need to prepare a background image on which the object does not appear in advance in order to perform the smoothing processing. Further, bumps in level are permissible on the synthesized image prior to implementation of the smoothing processing, and there is therefore no need to obtain a plurality of images through high-speed continuous shooting. In other words, a follow shot image can be synthesized at low cost using a plurality of images shot at a comparatively low continuous shooting speed. Furthermore, in the background part of the image, smoothing can be performed up to the vicinity of an object boundary, and therefore, in comparison with a conventional method of dividing an image into mesh-form areas and switching between use and non-use of a smoothing filter in each area, a follow shot image exhibiting a natural blur effect can be obtained.

With the image processing apparatus according to the first embodiment, a synthesized image is obtained by determining a motion vector between a plurality of images obtained in time series, correcting positional deviation between the plurality of images on the basis of the determined motion vector, and synthesizing the plurality of images subjected to positional deviation correction. Further, a smoothing area for performing smoothing processing is extracted on the basis of a degree of inconsistency following correction of the positional deviation between the plurality of images, and smoothing processing is performed in relation to the extracted smoothing area from among the respective areas of the synthesized image. As a result, a natural follow shot image exhibiting a natural blur effect can be obtained.

With the image processing apparatus according to the first embodiment in particular, the smoothing area is extracted on the basis of the first characteristic value, which indicates the degree of inconsistency between the plurality of images following positional deviation correction, and the second characteristic value, which indicates the effect of a positioning error generated during the positional deviation correction on the synthesized image. As a result, the area in which smoothing processing is to be performed can be extracted with a high degree of precision.

Further, a smoothing area characteristic value serving as an index for extracting the smoothing area is calculated on the basis of the first characteristic value and the second characteristic value, threshold processing is performed to compare the calculated smoothing area characteristic value with a predetermined threshold, and the smoothing area is extracted on the basis of a result of the threshold processing. Hence, the area in which smoothing processing is to be performed can be extracted with an even higher degree of precision.

By detecting the motion vector in a predetermined area in the central portion of the image, the motion vector can be detected reliably within the central area where the main object is highly likely to exist. Furthermore, in comparison with a case in which the motion vector is detected from the entire image, a calculation amount can be reduced.

Moreover, by detecting the motion vector within a predetermined area including the focus reference position, the motion vector can be detected reliably within the area where the main object is highly likely to exist.

Further, by detecting the motion vector on the basis of a color histogram of an area registered in advance by the user, the motion vector can be detected even more reliably.

### Second Embodiment

In the image processing apparatus according to the first embodiment, smoothing processing is performed on the synthesized image. In an image processing apparatus according to a second embodiment, image synthesis is performed after performing smoothing processing on the pre-synthesis images. In so doing, the degree of smoothing can be varied for each image, and as a result, an image having a smoother background can be obtained.

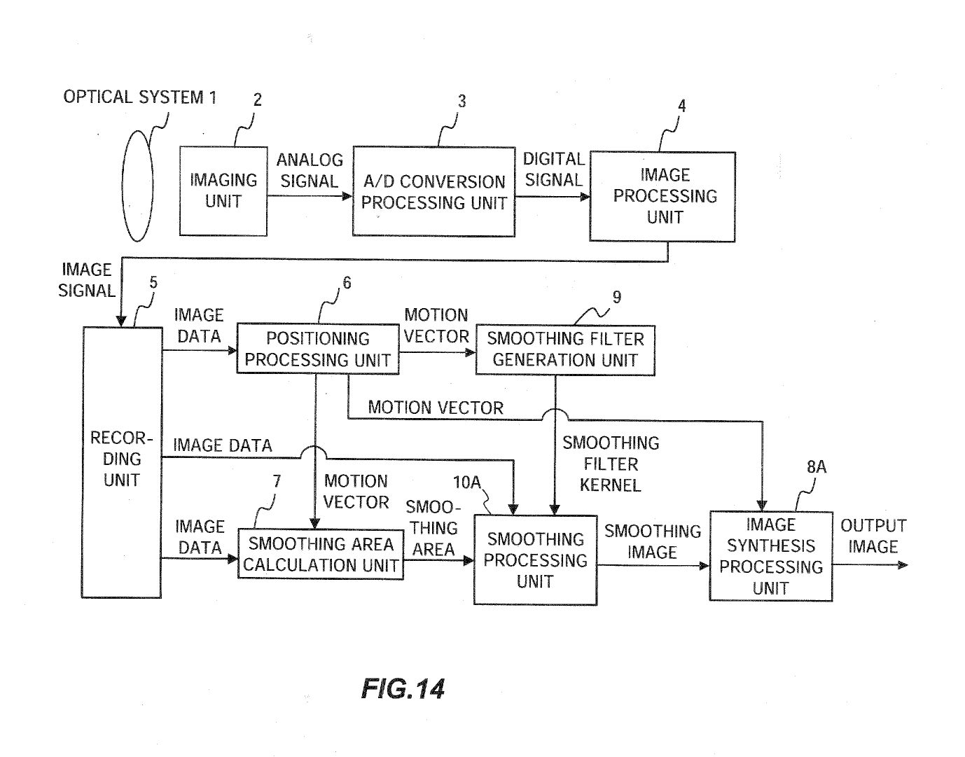

FIG. 14 is a view showing the constitution of the image processing apparatus according to the second embodiment. Identical constitutions to the constitutions of the image processing apparatus according to the first embodiment shown in FIG. 1 have been allocated identical reference numerals and detailed description thereof has been omitted. The image processing apparatus according to the second embodiment differs from the image processing apparatus according to the first embodiment in the content of the processing performed by a smoothing processing unit 10A and an image synthesis processing unit 8A.

The processing performed by the optical system 1, imaging unit 2, A/D conversion processing unit 3, image processing unit 4, recording unit 5, positioning processing unit 6, smoothing area calculation unit 7, and smoothing filter generation unit 9 is identical to that of the first embodiment. The smoothing processing unit 10A obtains smoothed images by performing smoothing processing on the image data of the plurality of images used during positioning on the basis of the smoothing filter kernel generated by the smoothing filter generation unit 9 and the smoothing area determined by the smoothing area calculation unit 7. The image synthesis processing unit 8A obtains an output image exhibiting a follow shot effect by performing image synthesis processing on the basis of the plurality of smoothed images obtained by the smoothing processing unit 10A and the motion vector.

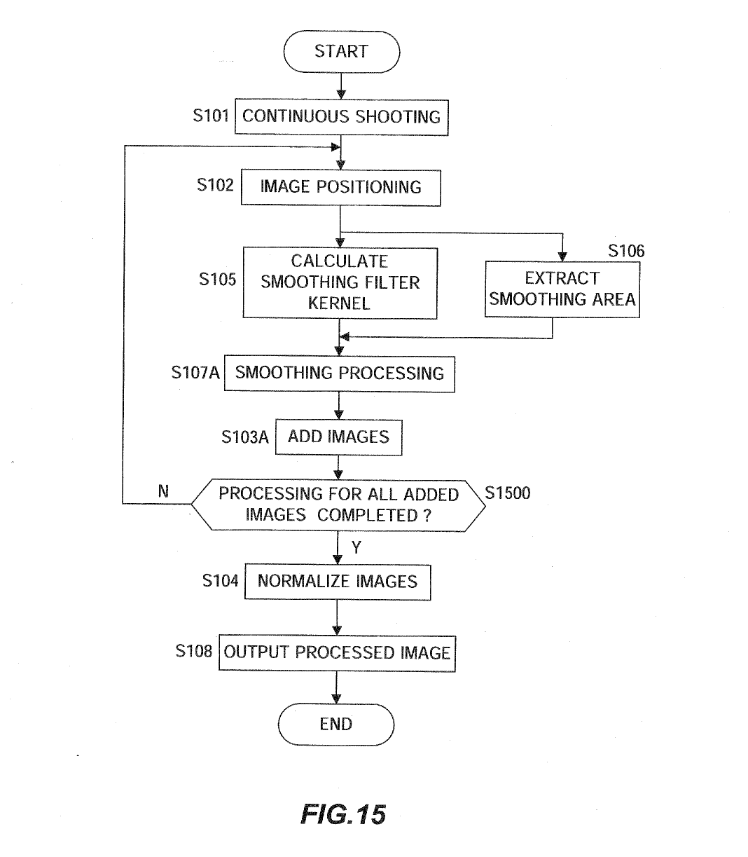

FIG. 15 is a flowchart showing the content of processing performed by the image processing apparatus according to the second embodiment. Steps in which identical processing to the processing of the flowchart shown in FIG. 2 is performed have been allocated identical step numbers and detailed description thereof has been omitted.

The processing of steps S101, S102, S105 and S106 is identical to the processing of the corresponding step numbers in the flowchart shown in FIG. 2. In a step S107A, the smoothing processing unit 10A performs smoothing processing on the data relating to the plurality of images used for positioning on the basis of the smoothing filter kernel determined in the step S105 and the smoothing area extracted in the step S106. More specifically, smoothing processing is performed on the luminance values of the pixels in the smoothing area extracted in the step S106, from among the luminance values of the respective pixels constituting the images used for positioning, using the smoothing filter kernel obtained in the processing of the step S105.

In a step S103A, the image synthesis processing unit 8A adds together the plurality of images subjected to smoothing processing in the step S107A while correcting positional deviation between the images on the basis of the motion vector determined in the step S102. In a step S1500, a determination is made as to whether or not the processing has been performed on all of the added images, or in other words whether or not an intended number of images to be added together have been added together in the step S103A. When it is determined that the processing has not been performed on all of the added images, the routine returns to the step S102, and when it is determined that the processing has been performed on all of the added images, the routine advances to a step S104.

In the step S104, the image synthesis processing unit 8A normalizes the added images by the addition count to obtain a synthesized image. In a step S108, the image synthesis processing unit 8A outputs the image obtained in the step S104.

In the second embodiment, smoothing processing is performed not only on the positioning subject frame but also on the reference frame. In the smoothing processing performed on the reference frame, smoothing processing is performed by determining a smoothing filter kernel on the basis of a motion vector relative to a positioning subject frame that is chronologically close to the reference frame. It should be noted, however, that the smoothing processing may be performed by determining a smoothing filter kernel on the basis of an average positional deviation of inter-frame positional deviation amounts. Moreover, smoothing processing need not be performed on the reference frame.

With the image processing apparatus according to the second embodiment, a motion vector between a plurality of images obtained in time series is determined, and a smoothing area for performing smoothing processing is extracted on the basis of the degree of inconsistency occurring when positional deviation between the plurality of images is corrected. Smoothing processing is then performed on the smoothing area, from among the respective areas of the plurality of images, whereupon the positional deviation between the plurality of images subjected to the smoothing processing is corrected on the basis of the motion vector and the plurality of images subjected to positional deviation correction are synthesized to obtain a synthesized image. As a result, a natural follow shot image exhibiting a natural blur effect can be obtained. In particular, image synthesis is performed after performing smoothing processing on the pre-synthesis images, and therefore the degree of smoothing can be varied for each image. As a result, an image having a smoother background can be obtained, whereby a natural follow shot image can be obtained.

The smoothing area is extracted on the basis of the first characteristic value, which indicates the degree of inconsistency between the plurality of images at the time of positional deviation correction, and the second characteristic value, which indicates the effect of the positioning error generated during the positional deviation correction on the synthesized image, and therefore the area in which the smoothing processing is to be performed can be extracted with a high degree of precision.

Further, a smoothing area characteristic value serving as an index for extracting the smoothing area is calculated on the basis of the first characteristic value and the second characteristic value, threshold processing is performed to compare the calculated smoothing area characteristic value with a predetermined threshold, and the smoothing area is extracted on the basis of the result of the threshold processing. Hence, the area in which smoothing processing is to be performed can be extracted with an even higher degree of precision.

By detecting the motion vector in a predetermined area in the central portion of the image, the motion vector can be detected reliably within the central area where the main object is highly likely to exist. Furthermore, in comparison with a case in which the motion vector is detected from the entire image, the calculation amount can be reduced.

Moreover, by detecting the motion vector within a predetermined area including the focus reference position, the motion vector can be detected reliably within the area where the main object is highly likely to exist.

Further, by detecting the motion vector on the basis of a color histogram of an area registered in advance by the user, the motion vector can be detected even more reliably.

In the above description of the first and second embodiments, it is assumed that the processing performed by the image processing apparatus is hardware processing, but this invention need not be limited to such a constitution. For example, a constitution in which the processing is performed by software may be employed. In this case, the image processing apparatus includes a CPU, a main storage device such as a RAM, and a computer-readable storage medium storing a program for realizing all or a part of the processing described above. Here, the program is referred to as an image processing program. By having the CPU read the image processing program stored on the storage medium and execute information processing/calculation processing, similar processing to that of the image processing apparatus described above is realized.

Here, a computer-readable storage medium denotes a magnetic disk, a magneto-optical disk, a CD-ROM, a DVD-ROM, a semiconductor memory, and so on. Further, the image processing program may be distributed to a computer by a communication line, whereupon the computer executes the received distributed image processing program.

This invention is not limited to the first and second embodiments described above, and may be subjected to various modifications and applications within a scope that does not depart from the spirit of the invention. For example, during motion vector calculation, the template block 21 set in the positioning subject frame 26 is scanned in the search area 22 of the reference frame 27 (see FIGS. 3A, 3B), but instead, a template block may be set in the reference frame and matching processing may be performed in relation to the template block in a search area of the positioning subject frame.

FIG. 9B shows an example of the filter kernel of the smoothing filter used in the smoothing processing, but the filter kernel is not limited to the example shown in FIG. 9B.

This application claims priority based on JP2009-31899, filed with the Japan Patent Office on Feb. 13, 2009, the entire contents of which are incorporated into this specification by reference.

What is claimed is:

1. An image processing apparatus comprising:
a motion vector determination unit that determines a motion vector between a plurality of images obtained in time series;
an image synthesis unit that obtains a synthesized image by correcting a positional deviation between the plurality of images on the basis of the determined motion vector and synthesizing the plurality of images subjected to the positional deviation correction;
a smoothing area extraction unit that extracts a smoothing area in which smoothing processing is to be performed on the basis of a degree of inconsistency occurring when the positional deviation between the plurality of images is corrected; and
a smoothing processing unit that performs the smoothing processing on the extracted smoothing area, from among respective areas of the synthesized image.

2. The image processing apparatus as defined in claim 1, further comprising:
a first characteristic value calculation unit that calculates a first characteristic value indicating the degree of inconsistency occurring between the plurality of images when the positional deviation between the plurality of images is corrected; and
a second characteristic value calculation unit that calculates a second characteristic value indicating an effect of a positioning error occurring during the positional deviation correction on the synthesized image,
wherein the smoothing area extraction unit extracts the smoothing area on the basis of the first characteristic value and the second characteristic value.

3. The image processing apparatus as defined in claim 2, further comprising:
a smoothing area characteristic value calculation unit that calculates, on the basis of the first characteristic value and the second characteristic value, a smoothing area characteristic value that serves as an index for extracting the smoothing area; and
a threshold processing unit that performs threshold processing in which the smoothing area characteristic value is compared with a predetermined threshold,
wherein the smoothing area extraction unit extracts the smoothing area on the basis of a result of the threshold processing performed by the threshold processing unit.

4. The image processing apparatus as defined in claim 2, wherein the first characteristic value calculation unit calculates at least one of a difference between a maximum value and a minimum value of luminance values, an absolute value of the difference between the maximum value and minimum value of the luminance values, a luminance value dispersion, a standard deviation of the luminance values, a hue difference, an absolute value of the hue difference, a hue dispersion, a standard deviation of the hue, a chroma difference, an absolute value of the chroma difference, a chroma dispersion, and a standard deviation of the chroma as the first characteristic value.

5. The image processing apparatus as defined in claim 2, wherein the second characteristic value calculation unit calculates a characteristic value indicating a luminance gradient of an image used to obtain the synthesized image as the second characteristic value.

6. The image processing apparatus as defined in claim 1, further comprising a filter kernel determination unit that determines, on the basis of the motion vector, a filter kernel of a smoothing filter used in the smoothing processing.

7. The image processing apparatus as defined in claim 1, wherein the motion vector determination unit determines the motion vector within a predetermined area in a central portion of an image.

8. The image processing apparatus as defined in claim 1, wherein the motion vector determination unit determines the motion vector within a predetermined area including a focus reference position.

9. The image processing apparatus as defined in claim 1, wherein the motion vector determination unit determines the motion vector on the basis of a color histogram of an area specified by a user.

10. An image processing apparatus comprising:
a motion vector determines unit that determines a motion vector between a plurality of images obtained in time series;
a smoothing area extraction unit that extracts a smoothing area in which smoothing processing is to be performed on the basis of a degree of inconsistency occurring when a positional deviation between the plurality of images is corrected;
a smoothing processing unit that performs the smoothing processing on the extracted smoothing area, from among respective areas of the plurality of images; and
an image synthesis unit that obtains a synthesized image by correcting the positional deviation between the plurality of images subjected to the smoothing processing on the basis of the motion vector and synthesizing the plurality of images subjected to the positional deviation correction.

11. The image processing apparatus as defined in claim 10, further comprising:
a first characteristic value calculation unit that calculates a first characteristic value indicating the degree of inconsistency occurring between the plurality of images when the positional deviation between the plurality of images is corrected; and
a second characteristic value calculation unit that calculates a second characteristic value indicating an effect of a positioning error occurring during the positional deviation correction on the synthesized image,
wherein the smoothing area extraction unit extracts the smoothing area on the basis of the first characteristic value and the second characteristic value.

12. The image processing apparatus as defined in claim 11, further comprising:
a smoothing area characteristic value calculation unit that calculates, on the basis of the first characteristic value and the second characteristic value, a smoothing area characteristic value that serves as an index for extracting the smoothing area; and
a threshold processing unit that performs threshold processing in which the smoothing area characteristic value is compared with a predetermined threshold,
wherein the smoothing area extraction unit extracts the smoothing area on the basis of a result of the threshold processing performed by the threshold processing unit.

13. The image processing apparatus as defined in claim 11, wherein the first characteristic value calculation unit calculates at least one of a difference between a maximum value and a minimum value of luminance values, an absolute value of the difference between the maximum value and minimum value of the luminance values, a luminance value dispersion, a standard deviation of the luminance values, a hue difference, an absolute value of the hue difference, a hue dispersion, a standard deviation of the hue, a chroma difference, an absolute value of the chroma difference, a chroma dispersion, and a standard deviation of the chroma as the first characteristic value.

14. The image processing apparatus as defined in claim 11, wherein the second characteristic value calculation unit calculates a characteristic value indicating a luminance gradient of an image used to obtain the synthesized image as the second characteristic value.

15. The image processing apparatus as defined in claim 10, further comprising a filter kernel determination unit that determines, on the basis of the motion vector, a filter kernel of a smoothing filter used in the smoothing processing.

16. The image processing apparatus as defined in claim 10, wherein the motion vector determination unit determines the motion vector within a predetermined area in a central portion of an image.

17. The image processing apparatus as defined in claim 10, wherein the motion vector determination unit determines the motion vector within a predetermined area including a focus reference position.

18. The image processing apparatus as defined in claim 10, wherein the motion vector determination unit determines the motion vector on the basis of a color histogram of an area specified by a user.

19. An electronic device having the image processing apparatus as defined in claim 1.

20. An electronic device having the image processing apparatus as defined in claim 10.

21. An image processing method comprising:
a step of determining a motion vector between a plurality of images obtained in time series;
a step of obtaining a synthesized image by correcting a positional deviation between the plurality of images on the basis of the determined motion vector and synthesizing the plurality of images subjected to the positional deviation correction;
a step of extracting a smoothing area in which smoothing processing is to be performed on the basis of a degree of inconsistency occurring when the positional deviation between the plurality of images is corrected; and
a step of performing the smoothing processing on the extracted smoothing area, from among respective areas of the synthesized image.

22. An image processing method comprising:
a step of determining a motion vector between a plurality of images obtained in time series;
a step of extracting a smoothing area in which smoothing processing is to be performed on the basis of a degree of inconsistency occurring when a positional deviation between the plurality of images is corrected;
a step of performing the smoothing processing on the extracted smoothing area, from among respective areas of the plurality of images; and
a step of obtaining a synthesized image by correcting the positional deviation between the plurality of images subjected to the smoothing processing on the basis of the motion vector and synthesizing the plurality of images subjected to the positional deviation correction.

23. A recording medium storing an image processing program, wherein the image processing program causes a computer to execute:
a step of determining a motion vector between a plurality of images obtained in time series;
a step of obtaining a synthesized image by correcting a positional deviation between the plurality of images on the basis of the determined motion vector and synthesizing the plurality of images subjected to the positional deviation correction;
a step of extracting a smoothing area in which smoothing processing is to be performed on the basis of a degree of inconsistency occurring when the positional deviation between the plurality of images is corrected; and
a step of performing the smoothing processing on the extracted smoothing area, from among respective areas of the synthesized image.

24. A recording medium storing an image processing program, wherein the image processing program causes a computer to execute:
a step of determining a motion vector between a plurality of images obtained in time series;
a step of extracting a smoothing area in which smoothing processing is to be performed on the basis of a degree of inconsistency occurring when a positional deviation between the plurality of images is corrected;
a step of performing the smoothing processing on the extracted smoothing area, from among respective areas of the plurality of images; and
a step of obtaining a synthesized image by correcting the positional deviation between the plurality of images subjected to the smoothing processing on the basis of the motion vector and synthesizing the plurality of images subjected to the positional deviation correction.
